(19) United States
(12) Patent Application Publication
(10) Pub. No.: US 2010/0149651 A1
(43) Pub. Date: Jun. 17, 2010

(54) VARIABLE-FOCUS LENS ASSEMBLY

(75) Inventors: Bruno Berge, Lyon (FR); Jérôme Peseux, Solaize (FR); Bertrand Boutaud, Lyon (FR); Pierre Craen, Lyon (FR)

Correspondence Address: OSHA LIANG L.L.P., TWO HOUSTON CENTER, 909 FANNIN, SUITE 3500, HOUSTON, TX, 77010, US

(73) Assignee: Varioptic

(21) Appl. No.: 11/993,140

(22) PCT Filed: Jun. 23, 2006
(86) PCT No.: PCT/EP2006/063519

§ 371 Date: Dec. 19, 2007

(30) Foreign Application Priority Data
Jun. 23, 2005 (FR) 0551735

(51) Int. Cl. G02B 3/14

(52) U.S. Cl. 359/666; 359/667

(57) ABSTRACT

The present invention relates to an electrowetting-based variable-focus lens comprising an enclosure with at least two components, an arrangement of first and second immiscible liquids (5, 6) contained in said enclosure, wherein the liquids have different refractive indices and are in contact over a moveable refractive optical interface, a first electrode associated with one of said liquids, the electrode comprising a film (21, 22; 23, 24) of conducting material extending from a region internal to the enclosure to a region external to the enclosure, wherein the conducting material forms a bonding element between said components of the enclosure.

### FIELD OF THE INVENTION

The present invention relates to variable-focus lenses of the type comprising at least two liquids of different refractive indices, the curvature of the refractive interface between the two liquids being controlled by electrowetting.

### PRIOR ART

Such electrowetting-based variable-focus lenses have been described in a general way in European Patent 1 019 758.

The present invention relates more particularly to the assembly of a variable-focus lens. Conventionally, these assemblies comprise at least some metal components.

### SUMMARY OF THE INVENTION

One object of the present invention is to produce a particularly simple and compact assembly comprising only insulating components, for example made of glass and ceramic, having particularly simple structures.

Another object of the present invention is to produce lenses capable of operating within relatively wide temperature ranges, notwithstanding the possible expansions of the liquids constituting the lens.

To achieve these objects, according to a first aspect of the present invention there is provided an electrowetting-based variable-focus lens enclosure comprising at least one electrode associated with at least one liquid contained in the enclosure, the electrode comprising a film of conducting material extending from a region internal to the enclosure to a region external to the enclosure, wherein said conducting material provides a bonding element between constituent components of the enclosure.

According to one embodiment of the present invention, said conducting material is a tin-based alloy, such as a tin-gold alloy, an indium-based alloy, a bismuth-based alloy or a lead-based alloy.

According to one embodiment of the present invention, the enclosure contains at least an insulating liquid and a conducting liquid, in which enclosure the side walls of the region containing the insulating liquid are coated with a conducting film, possibly comprising of said conducting material, itself coated with an insulating film.

According to a further aspect of the present invention there is provided an enclosure comprising two transparent windows and an annular ring made of rigid insulating materials, at least one transparent window being bonded to the ring by means of a film of conducting material as defined above, a first electrode being in contact with a conducting liquid and a second electrode being associated with an insulating liquid, a film of said conducting material being formed on facing parts of the ring and on at least one of the windows.

According to one embodiment of the present invention, the ring is made of a ceramic.

According to one embodiment of the present invention, the enclosure comprises two components made of at least one transparent material each comprising a central part in the form of a window and an annular rim having a planar face, said planar faces facing each other, a first electrode being in contact with a conducting liquid and a second electrode being associated with an insulating liquid, in which enclosure said film of conducting material extends over at least part of one of said planar faces.

According to one embodiment of the present invention, for one of the two components, the internal periphery of the annular rim and at least the external periphery are coated with a conducting film which is itself coated with an insulating film on the internal wall of the annular rim and on the planar face of the annular rim, and with a film of said conducting material which extends over at least part of the planar face of the rim opposite the other of the two components.

According to one embodiment of the present invention, the enclosure comprises expansion-absorbing means in communication with the at least one liquid of the lens.

According to one embodiment of the present invention, the expansion-absorbing means comprises at least one cavity formed in at least one of the constituent components of the enclosure, said cavity or cavities being filled with a compressible gas.

According to one embodiment of the present invention, the melting point of said conducting material is below the melting point of the materials comprising the conducting film and the insulating film.

### BRIEF DESCRIPTION OF THE DRAWINGS

These objects, features and advantages, and also others of the present invention will be explained in detail in the following non-limiting description of particular embodiments in relation to the appended figures in which:

FIG. 1 is an exploded sectional view of a variable-focus lens assembly according to a first embodiment of the present invention; and

FIG. 2 is an exploded sectional view of a variable-focus lens assembly according to a second embodiment of the present invention.

### DETAILED DESCRIPTION

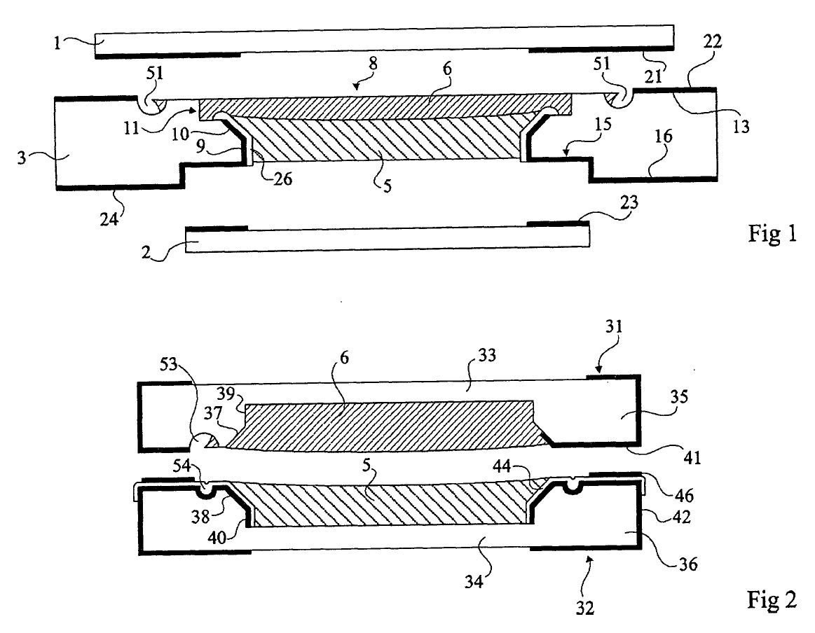

In a first embodiment of the present invention illustrated in FIG. 1, a variable-focus lens structure comprises upper and lower transparent plates 1 and 2 and an annular ring 3. Seen from above, the plates and the ring are circular. In order to make the invention more clearly understood, the constituent liquids of the electrowetting-based variable-focus lens have been shown inside the ring in the position that they have once the structure has been assembled. In the embodiment shown, these liquids comprise an insulating liquid 5 and a conducting liquid 6 which are placed in the central opening 8 of the annular ring. This central opening is bounded, for example as shown, by a vertical lower cylindrical wall 9, a truncated-cone-shaped wall (i.e. conical frustrum) flaring outwards from its join with the wall 9, and an upper cylindrical wall 11 of larger diameter than the diameter of the upper part of the truncated cone 10. At rest, the boundary between the insulating liquid 5 and the conducting liquid 6 is level with the upper part of the truncated cone 10.

The ring 3 further comprises on its upper surface, a planar face 13 on which the upper plate 1 is intended to bear in order to form the top side of an enclosure. The lower face of the ring 3 comprises a planar bearing surface 15 for the plate 2, which bearing surface may be recessed relative to the lower surface 16 of the ring 3. It should be noted that a similar recess could be provided on the upper face of the ring in such a way that, after assembly, the upper surface of the upper plate 1 will be substantially level with the upper peripheral part of the ring.

The plates 1 and 2 and the ring 3 are made of rigid insulating materials, for example glass in the case of the plates 1 and 2, which must be transparent to the intended operating wavelengths of the lens, and a ceramic, for example alumina, in the case of the ring 3.

The present invention aims more particularly at the production of the electrodes for controlling the variable-focus lens and to the assembly of the elements of the enclosure or module.

The external periphery of the lower face of the upper plate 1 is coated with a conducting film 21 that extends so as to come into contact via its internal part with the conducting liquid 6. The external part of the conducting film 21 is intended to bear on an internal part of the planar face 13 of the ring 3. Also deposited on this planar face 13 is a conducting film 22 that extends towards the external periphery of the ring 3. The conducting films 21 and 22 are made of materials having electrical conductivity sufficient for them to act as good electrodes and to adhere, on one side, to the plate 1 and, on the other side, to the ring 3, these materials forming, after being heated, a bond so as to seal the connection between the plate 1 and the ring 3. For example, a tin alloy, such as a gold-tin alloy, an indium-based alloy, a bismuth-based alloy or a lead-based alloy may be used.

The upper face of the lower plate 2 comprises a metallization 23 on its external periphery facing the recessed bearing surface 15 of the lower face of the ring 3. It should be noted that such a recess is not a necessary feature of embodiments of the invention but is only intended to make assembly easier. According to an alternative embodiment of the present invention, when the metallization 23 comprises a material allowing the production of a transparent film, the metallization 23 may be deposited over the entire upper face of the lower plate 2.

The lower face of the ring is coated with a conducting film 24, which is extended over the walls of the right cylinder 9 and of the truncated conical part 10. On the walls 9 and 10, the conducting film 24 is coated with an insulator 26. The insulator 26 may comprise a hydrophobic material or it may be coated with a hydrophobic material. The materials of the conducting layers 23 and 24 are of the same nature as the materials of the conducting layers 21 and 22. In operation, when a variable voltage is applied between contacts made on the upper and lower external peripheries of the ring, the focal length of the lens is modified under the effect of the variation in electrowetting along the walls of the truncated cone 10, as is described in particular in the above-mentioned patent.

FIG. 2 is an exploded sectional view illustrating a second embodiment of an electrowetting-based variable-focus lens enclosure according to an embodiment of the present invention. This enclosure comprises only two components, an upper component 31 and a lower component 32, these preferably being identical in order to simplify the manufacture. These two components are made of a transparent insulating material, for example glass. These two components preferably have, seen from above, a circular shape. Each of these components comprises, in its central part, a plate 33, 34, for example with parallel faces, and, in its peripheral part, an annular protuberance or rim 35, 36. It may also be considered that each of these components comprises a parallel-faced disc having at its centre a cavity, the depth of which is limited so as to define the central parts 33, 34. The cavities that are formed in the components 31-31 comprise, on the one hand, a truncated-cone-shaped portion 37, 38 and, on the other hand, a right cylinder portion 39, 40 that intersects the truncated conical portion. The opposed faces of the annular protuberances 35, 36 are intended to be brought together and bonded to each other.

The upper component 31 is coated with a conducting film 41 that extends towards the inside of the protuberance 35 up to a point where it is in contact with the region that must contain the conducting liquid 6 (in the position that it would have once the lens has been assembled) and extends towards the outside beyond the point of the contact region between the components 31 and 32. In the embodiment shown, the conducting film 41 extends along the side wall of the component 31 as far as a peripheral portion of the upper face of the component 31.

The lower component 32 is coated with a conducting film 42, which extends along the walls of the cylindrical and truncated-cone-shaped portions 38, 40 of the central cavity intended to contain the insulating liquid 5 and which is extended to the outside, for example by extending along the side wall of the component 32 as far as a peripheral portion of the lower face of the component 32.

An insulating film 44 is provided in order to prevent any contact between the conducting film 42 and, on the one hand, the conducting liquid 6 and, on the other hand, the conducting film 41 of the upper component 31. Furthermore, a conducting film 46 is deposited on the insulating film 44 of the lower component 32 facing, at least partly, that portion of the conducting film 41 formed on the lower face of the upper component 31. The insulating film 44 may comprise a hydrophobic material or may be covered with a hydrophobic material.

The conducting films 41 and 46 are intended to be bonded together and will preferably comprises materials of the same type as those described above in the case of the conducting films 22 to 24 of the first embodiment. For example, it may be a low-melting point material. The conducting film 42 may be made of any appropriate conducting material given that it is not involved in the bond. For example, if the conducting films 41, 46 are made of a tin-gold alloy, the conducting film 42 may be made of gold, or any other conducting material. The conducting film 42 is preferably made of a material having a melting point substantially above the melting point of the constituent material of the conducting films 41, 46 and of the constituent material of the insulating film 44. The insulating film 44 may be made of silicon oxide or silicon nitride.

The first and second embodiments are capable of many structural variations that will be apparent to those skilled in the art. For example, the conducting films 21 and 23 of the first embodiment may be continued over the opposed end faces of the plates 1 and 2. A person skilled in the art will also understand that everywhere metallizations have to go over corners, these corners will preferably be rounded so as to simplify the method of depositing the metallization and to avoid any breaks in the metallization.

Moreover, a specific shape of the cavity formed in this sealed enclosure has been described, but any suitable internal shape known in the art may be used. For example, a single right cylinder, or a cone extending as far as the end of the plate in question, for example a truncated conical wall 10 extending as far as the bearing surface 15, or truncated-cone-shaped portions 37, 38 extending as far as the bottom of the cavity formed in the components 31, 32, may be provided.

In the case of the first embodiment, the ring 3 and the lower plate 2 may both be entirely made of glass. If the ring is made of ceramic and the lower plate made of glass, provision may be made for the lower plate to be mounted beforehand on the ceramic ring by any means. Likewise, each of the components 31, 32 may be formed in two parts, namely a plate and a ring affixed to this plate. In general, plates 1, 2, 33, 34 can comprise any type of transparent window formed of a transparent material.

Examples of variable-focus lenses containing two liquids have been described, but it should be noted that lenses containing more than two liquids may be provided.

One method of assembly of the upper plate 1 on the ring 3 or of assembling the two components 31 and 32 will now be indicated by way of example. According to one particular method of implementing the invention, the assembly operation is carried out by firstly immersing the component 32 or the plate 2/ring 3 combination in a bath filled with the conducting liquid 6. Next, the chosen quantity of the insulating material 5 is injected, for example using a syringe, and the upper plate 1 or the upper component 31 is placed on the lower component 32 or combination 2/3. The bond between the upper plate or component and the lower component may be provided by locally heating the periphery of the structure. In one particular method of implementing the present invention, this may be carried out by heating the periphery of the component by laser irradiation. The conducting films 21, 22 or 41, 46 then melt and form an impermeable join. The laser irradiation may be carried out while the components are immersed.

Thus, embodiments of the present invention make it possible to obtain a particularly rigid and non-deformable variable-focus lens structure.

However, this structure may have a drawback in that, if it is subjected to large temperature variations, given that the constituent materials of the enclosure are practically non-deformable whereas the liquids that it contains are capable of expanding, the structure may crack or burst. To avoid this problem, if it is likely to occur, embodiments of the present invention provide a means of absorbing the expansion of the liquids. This means is formed, in the embodiments shown in FIGS. 1 and 2, by the presence of one or more cavities filled with a compressible gas in communication with that region of the enclosure containing the liquids of the lens. FIG. 1 shows an annular channel 51 formed in the upper face 13 of the ring 3. This annular channel communicates, by means that are not shown, possibly simply by a non-impermeable join between the upper plate 1 and the ring 3 in the part separating this annular channel from the central opening 8 of the ring containing the liquid 6. Likewise, in the embodiment shown in FIG. 2, channels 53, 54 formed in the facing protuberances of the components 31 and 32 are provided. In the embodiment illustrated, the conducting film 41 is interrupted at certain places so as not to fill the channel 53. The channels 53, 54 may be completely annular or occupy only part of the periphery of the upper and lower components. It should be noted that the channel 54 can be filled with the conducting film 42 and insulating film 44. However, a person skilled in the art will know to choose the depth of the channels so that, at least on one side (on the upper plate or on the lower plate), there remains a recess sufficient to fulfil the expansion-absorbing function.

Various means may be used for introducing a compressible gas into the channels. For example, in the first embodiment of the present invention, once the lens has been filled with the liquids 5 and 6, the upper plate may be positioned slightly offset with respect to the axis of the lens so as to expose at least part of the channel 51. The system will then be placed in an environment containing a chosen gas, for example simply air, and a little of the liquid will be removed so that air fills at least part of the channel. Next, when a change in temperature occurs, the constituent liquid of the lens will be able to fill the channel to a greater or lesser extent.

According to another method of implementing the present invention, applicable to the first and second embodiments of the present invention, the channels 51 or 53, 54 will be filled via access apertures provided in one of the constituent components of the lens. These access apertures are used for injecting a gas by means of a syringe and for simultaneously removing the liquid initially present in the enclosure. After this gas injection, a “plug”, for example a drop of solder, will be put into place in order to close off the access apertures.

The expansion-compensating means have been described in the two embodiments of the present invention as cavities or channels filled with a compressible gas in communication with at least one of the liquids contained in the central region of the lens. However, any other expansion-absorbing means may be provided, for example a deformable material, for example a very soft elastomer, placed in such channels, or else an enclosure filled with a compressible gas, placed in one of the channels or cavities described above, or in the central region of the lens containing the compressible liquids, at a place where this does not impede the propagation of a light beam through the lens.

Variable focus lenses according to the invention can be incorporated in a large variety of optical devices, such as, for example, camera modules for mobile phones, endoscope systems, barcode readers, personal digital organisers, etc.

1. Electrowetting-based variable-focus lens comprising:
an enclosure with at least two components,
an arrangement of first and second immiscible liquids (5, 6) contained in said enclosure, wherein the liquids have different refractive indices and are in contact over a moveable refractive optical interface,
a first electrode associated with one of said liquids, the electrode comprising a film (21, 22; 23, 24; 41, 42) of conducting material extending from a region internal to the enclosure to a region external to the enclosure, wherein the conducting material forms a bonding element between said components of the enclosure.

2. Lens according to claim 1, wherein said conducting material comprises a tin-based alloy, such as a tin-gold alloy, an indium-based alloy, a bismuth-based alloy or a lead-based alloy.

3. Lens according to claim 1, wherein one liquid is an insulating liquid (5) and the other liquid is a conducting liquid (6), the enclosure comprises side walls (9, 10; 38, 40) in contact with said insulating liquid, and said side walls are coated with a conducting film (24; 42), itself coated with an insulating film (26; 44).

4. Lens according to claim 3, wherein the conductive film comprises said conducting material.

5. Lens according to claim 1, wherein the enclosure comprises two transparent windows (1, 2) and an annular ring (3) made of a rigid insulating material, and at least one transparent window is bonded to the ring by means of a film of said conducting material.

6. Lens according to claim 5, wherein the ring is made of a ceramic.

7. Lens according to claim 1, wherein the enclosure comprises two components (31, 32), and wherein each component comprises a central part (33, 34) in the form of a plate and made of a transparent material, and an annular rim (35, 36) having a planar face, said planar faces of said components facing each other, and wherein said film of conducting material extends over at least part of one of said planar faces.

8. Lens according to claim 7, wherein the annular rim (36) of at least one of the said components has an internal periphery and an external periphery coated with a conducting film (42) which is itself coated with an insulating film (44) on the internal periphery and on the planar face of the annular rim, and wherein a film (46) of said conducting material extends over at least part of the planar face of the rim (35).

9. Lens according to claim 8, in which the melting point of said conducting material is below the melting point of the materials forming the conducting film (42) and the insulating film (44).

10. Lens according to claim 1, which comprises expansion-absorbing means in communication with at least one liquid (5, 6) of the lens.

11. Enclosure according to claim 10, in which the expansion-absorbing means comprises at least one cavity (51; 53, 54) formed in at least one of the components of the enclosure, said cavity or cavities being filled with a compressible gas.

12. Camera module comprising a lens according to claim 1.

13. Mobile phone comprising a camera module according to claim 12.
